(19) United States
(12) Patent Application Publication
(10) Pub. No.: US 2026/0199864 A1
(43) Pub. Date: Jul. 16, 2026

(54) METHODS FOR PROCESSING CHEMICALS AND REACTOR SYSTEMS UTILIZING TUBULAR REACTORS

(71) Applicant: DOW GLOBAL TECHNOLOGIES LLC, Midland, MI (US)

(72) Inventors: Cornelis Biesheuvel, Hoek (NL); Wim Kamperman, Middelburg (NL); Albert Destrehan Harvey, Conroe, TX (US); Govert Gerardus Pieter Van Der Ploeg, Amsterdam (NL); David Booth Burns, Houston, TX (US)

(73) Assignee: DOW GLOBAL TECHNOLOGIES LLC, Midland, MI (US)

(21) Appl. No.: 19/137,882

(22) PCT Filed: Dec. 11, 2023
(86) PCT No.: PCT/US2023/083291

§ 371 Date: Jun. 11, 2025

Related U.S. Application Data
(60) Provisional application No. 63/432,168, filed on Dec. 13, 2022.

(51) Int. Cl. B01J 19/00; B01J 19/24; C10G 9/20; C10G 9/24; C10G 9/36

(52) U.S. Cl. CPC B01J 19/0013; B01J 19/2415; C10G 9/20; C10G 9/24; C10G 9/36; B01J 2219/00135

(57) ABSTRACT

A method for processing chemicals may include passing a hydrocarbon feed stream through an inlet of a tubular reactor positioned at least partially within an enclosure. The enclosure may include at least one heating element positioned between an interior surface of the side wall of the enclosure and an exterior surface of the wall of the tubular reactor. The method includes passing a first electrical current through the wall of the tubular reactor to heat at least a portion of the wall of the tubular reactor, and passing a second electrical current through the heating element to heat the heating element such that heat transfers from the heating element to the wall of the tubular reactor. The method includes reacting at least a portion of the hydrocarbon feed stream within the tubular reactor to form a product stream, and passing the product stream through the outlet of the tubular reactor.

### CROSS-REFERENCE TO RELATED APPLICATIONS

This application claims the benefit of U.S. Provisional Application Ser. No. 63/432,168 filed Dec. 13, 2023, the entire disclosure of which is hereby incorporated herein by reference.

### TECHNICAL FIELD

Embodiments described herein generally relate to methods and systems for chemical processing.

### BACKGROUND

Various chemicals may be produced by reacting a feed stream in a reactor system, such as a tubular reactor, to form a product stream. Some reactions that may take place in such a reactor system are endothermic, such as steam cracking and steam methane reformation. Heat may be supplied to the reactor system to drive such reactions.

Conventional heating methods rely on the on-site combustion of fossil fuels to provide process heat, which may lead to greenhouse gas emissions. For example, in some conventional reactor systems, numerous fuel gas burners are employed to radiate heat from the combustion of fuel gas onto and through tubular reactor walls to provide heat to hydrocarbon feedstocks and drive an endothermic reaction to form desired products. The availability of renewable electricity creates an opportunity to use renewable energy to provide heat, eliminating the need to burn fossil fuels, which leads to lower emissions. Accordingly, there is a need for improved systems and methods for processing chemicals using electricity to provide heat to the reactor system.

### SUMMARY

Embodiments of the present disclosure are directed to reactor systems that utilize both electric radiant heating techniques and direct resistive heating techniques to provide heat to tubular reactors using electricity. The reactor system may include one or more tubular reactors positioned within an enclosure. Electrical heating elements may be positioned within the enclosure to heat the tubular reactors by radiant heating. Additionally, the walls of the tubular reactors themselves may be heated by direct electric resistance heating. The combination of radiant heating from the electric heating elements and direct resistive heating of the walls of the tubular reactor may provide the heat necessary to drive an endothermic reaction within the tubular reactor. Additionally, without being bound by any particular theory, the use of both radiant heating and resistive heating may allow the reactor system to have greater operational flexibility, may reduce mechanical stresses within the reactor system, may allow for the use of less exotic materials for the tubular reactor and heating elements, and may allow for more freedom in the arrangement of the heating elements and tubular reactors within the reactor system. Thus, the combination of direct resistance heating and radiant heating may be advantageous over conventional heating methods.

According to one or more embodiments of the present disclosure, a method for processing chemicals may comprise passing a hydrocarbon feed stream through an inlet of a tubular reactor. The tubular reactor may comprise the inlet, an outlet, and a wall extending at least from the inlet to the outlet. The tubular reactor may be positioned at least partially within an enclosure. The enclosure may comprise a first end, a second end, and at least one side wall extending from the first end to the second end. The enclosure may comprise at least one heating element positioned between an interior surface of the side wall of the enclosure and an exterior surface of the wall of the tubular reactor. The method for processing chemicals may comprise passing a first electrical current through at least a portion of the wall of the tubular reactor to heat at least a portion of the wall of the tubular reactor, and passing a second electrical current through the heating element to heat at least a portion of the heating element such that heat transfers from the heating element to the wall of the tubular reactor. The method comprises reacting at least a portion of the hydrocarbon feed stream within the tubular reactor to form a product stream, and passing the product stream through the outlet of the tubular reactor.

According to one or more additional embodiments of the present disclosure, a reactor system may comprise a tubular reactor comprising an inlet, an outlet, and a wall extending at least from the inlet to the outlet. The wall of the tubular reactor may be connected to a first electrical current source such that at least a portion of the tubular reactor is operable to be heated when the first electrical current is passed through the tubular reactor. The reactor system may comprise an enclosure comprising a first end, a second end, and at least one side wall extending from the first end to the second end, and at least one heating element positioned between an interior surface of the side wall of the enclosure and an exterior surface of the wall of the tubular reactor. The heating element may be connected to a second electrical current source. The tubular reactor may be positioned at least partially within the enclosure, such that the heating element is operable to heat at least a portion of the tubular reactor when the second electrical current passes through the heating element.

Additional features and advantages of the technology disclosed herein will be set forth in the detailed description which follows, and in part will be readily apparent to those skilled in the art from that description or recognized by practicing the technology as described herein, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a reactor system comprising a tubular reactor, according to one or more embodiments disclosed herein;

FIG. 2 schematically depicts a reactor system comprising a tubular reactor with a “U shape,” according to one or more embodiments described herein; and

FIG. 3 schematically depicts a reactor system comprising multiple tubular reactors, according to one or more embodiments described herein.

### DETAILED DESCRIPTION

One or more non-limiting embodiments are described herein. As described herein, methods for processing chemicals may include passing hydrocarbon feed streams through inlets of a tubular reactors, reacting at least a portion of the hydrocarbon feed streams to form product streams, and passing the product streams from the tubular reactor. The tubular reactor may be positioned within an enclosure, and the tubular reactor may be heated by radiant heating from heating elements positioned within the enclosure and by resistive heating of the wall of the tubular reactor. Without intending to be bound by theory, the use of both radiant heating and resistive heating may allow the system to have greater operational flexibility, may reduce mechanical stresses within the reactor system, may allow for the use of less exotic materials for the tubular reactor and heating elements, and may allow for more freedom in the arrangement of the heating elements and tubular reactors in the reactor system. These advantages, as well as others, are described in detail hereinbelow.

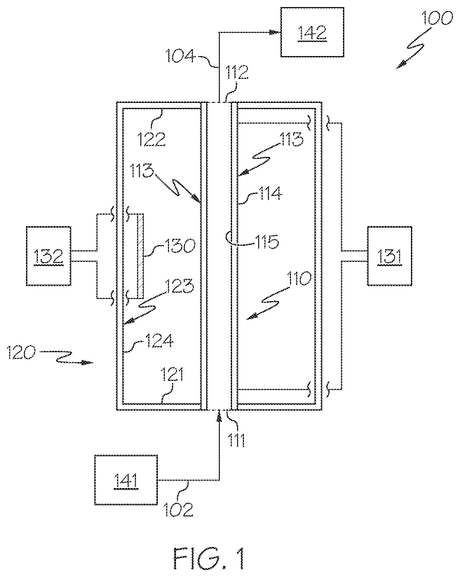

Referring now to FIG. 1, a hydrocarbon feed stream 102 may be passed to a tubular reactor 110. FIG. 1 depicts a cross section of the tubular reactor 110, as can be understood by those skilled in the art. As described herein, a “reactor” refers to a vessel suitable for a given chemical reaction. A “tubular reactor” may refer to a reactor having a substantially tubular shape such that reactants and products pass from an inlet to an outlet of the reactor. Tubular reactors are described in greater detail herein. The tubular reactor 110 may be part of a reactor system 100. The reactor system 100 may include one or more tubular reactors 110 and an enclosure 120 as described in greater detail herein.

In one or more embodiments, the tubular reactor 110 may comprise an inlet 111, an outlet 112, and a wall 113. The wall 113 may have a substantially circular cross-sectional shape. The wall may comprise an interior surface 115 and an exterior surface 114. The wall 113 may extend from at least the inlet 111 to the outlet 112 of the tubular reactor 110. In one or more embodiments, the wall 113 may extend from the inlet 111 to the outlet 112 of the tubular reactor 110. In such embodiments, the inlet 111 and the outlet 112 may be positioned at opposite ends of the tubular reactor 110. In one or more embodiments, which are not depicted, the wall 113 may extend past the inlet 111 or the outlet 112 or both. In such embodiments, the inlet 111 or the outlet 112 may not be positioned exactly at an end of the tubular reactor 110. However, the inlet 111 and the outlet 112 may be positioned sufficiently close to the ends of the tubular reactor 110 to not significantly impair the functionality of the tubular reactor 110. For example, the inlet 111 or the outlet 112 may be an opening in the wall 113 of the tubular reactor 110 proximate an end of the tubular reactor 110 while the end of the tubular reactor 110 is closed.

In one or more embodiments, the tubular reactor 110 may have a cross-sectional area that is substantially constant from the inlet 111 of the tubular reactor 110 to the outlet 112 of the tubular reactor 110. As described herein, the cross-sectional area of the tubular reactor 110 is perpendicular to the bulk flow the hydrocarbon feed stream through the tubular reactor 110. As described herein, a cross-sectional area may be “substantially constant” when the cross-sectional area varies by less than 15%, less than 10%, less than 5%, or even less than 1% over the length of the tubular reactor 110 from the inlet 111 of the tubular reactor 110 to the outlet 112 of the tubular reactor 110. It should be noted that individual particles or molecules within a phase may move in a direction different from, or even opposite to, the bulk flow of a phase, without affecting the direction of the bulk flow of that phase. For example, and without limitation, individual hydrocarbon molecules within the hydrocarbon feed stream 102 may move in a direction different from the bulk flow of the hydrocarbon feed stream 102 without affecting the direction of the bulk flow of the hydrocarbon feed stream 102. In one or more embodiments, the bulk flow of the hydrocarbon feed stream 102 through the tubular reactor 110 may be substantially plug flow from the inlet 111 of the tubular reactor 110 to the outlet 112 of the tubular reactor 110.

The tubular reactor 110 may have any suitable cross-sectional shape. In one or more embodiments, the tubular reactor 110 may have a closed curved cross-sectional shape, a polygonal cross-sectional shape, or a combination thereof. For example, and without limitation, the tubular reactor 110 may have a cross-sectional shape such as a circle, oval, or ellipse, a triangle, rectangle, pentagon, hexagon, etc., or a combination of these. In some embodiments, the tubular reactor 110 may have a substantially circular cross-sectional shape.

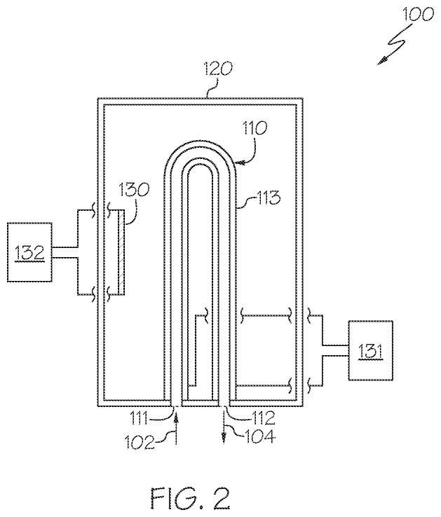

In one or more embodiments, the wall 113 of the tubular reactor 110 may comprise one or more bends between the inlet 111 of the tubular reactor 110 and the outlet 112 of the tubular reactor 110. For example, and without limitation, the wall 113 of the tubular reactor 110 may comprise a single bend and have a “U” shape, or the wall 113 of the tubular reactor 110 may comprise two or more bends and have an “S” shape, “M” shape, “W” shape, or other shape. Referring now to FIG. 2, in some embodiments, the wall 113 of the tubular reactor 110 comprises a single bend and the tubular reactor 110 has a “U” shape.

Referring again to FIG. 1, the wall 113 of the tubular reactor 110 may be straight, or substantially free from bends. In such embodiments, the wall 113 of the tubular reactor 110 may have a substantially hollow-cylindrical shape. As described herein, a hollow-cylindrical shape has an annular cross-sectional shape when the cross-section is a radial cross-section relative to the hollow cylinder.

The tubular reactor 110 may be positioned at least partially within an enclosure 120. In one or more embodiments, the enclosure 120 may comprise a first end 121, a second end 122, and at least one side wall 123 extending from the first end 121 to the second end 122. In one or more embodiments, the at least one side wall 123 may have an interior surface 124. The interior surface 124 of the at least one side wall 123 may be spaced apart from the exterior surface 114 of the wall 113 of the tubular reactor 110. In other words, the interior surface 124 of the at least one side wall 123 of the enclosure 120 may not be in direct contact with the exterior surface 114 of the wall 113 of the tubular reactor 110. For example, conductive heating may not be possible on the tubular reactor 110 by the heating element 130.

In one or more embodiments, the inlet 111 of the tubular reactor 110 may be positioned at the first end 121 of the enclosure 120 and the outlet 112 of the tubular reactor 110 may be positioned at the second end 122 of the enclosure. In such embodiments, the tubular reactor 110 may span the enclosure 120 from the first end 121 of the enclosure 120 to the second end of the enclosure 122. In one or more embodiments, the wall 113 of the tubular reactor may comprises one or more bends, and the inlet 111 of the tubular reactor 110 and the outlet 112 of the tubular reactor may be positioned on the same end of the enclosure 120. For example, and without limitation, the inlet 111 of the tubular reactor 110 and the outlet 112 of the tubular reactor 110 may both be on the first end 121 of the enclosure 120 or on the second end 122 of the enclosure. Referring again to the embodiment depicted in FIG. 2, the inlet 111 and outlet 112 of the tubular reactor 110 are both positioned at the first end 121 of the enclosure 120.

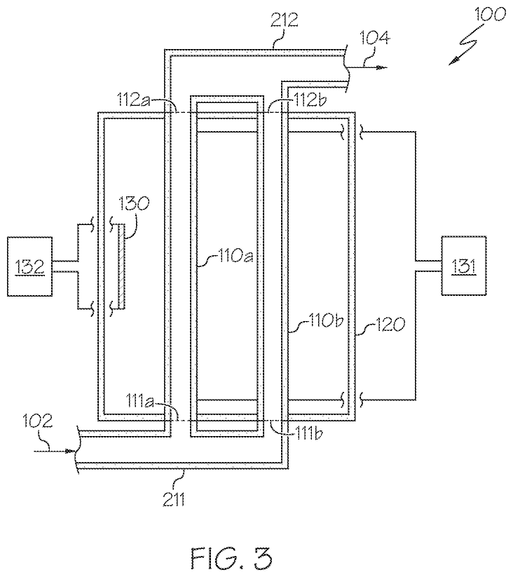

Referring now to FIG. 3, more than one tubular reactor 110 may be positioned at least partially within the enclosure 120. For example, in the embodiment depicted in FIG. 3, two tubular reactors 110a and 110b are positioned within enclosure 120. In one or more embodiments, from 2 to 50 tubular reactors 110 may be positioned within the enclosure 120. For example, and without limitation, the number of tubular reactors 110 positioned within the enclosure 120 may be from 2 to 50, from 10 to 50, from 20 to 50, from 30 to 50, from 40 to 50, from 2 to 40, from 2 to 30, from 2 to 20, from 2 to 10 or any combination or subset of these endpoints. Generally, each tubular reactor 110 may be in direct line of sight with one or more heating element 130.

In embodiments where more than one tubular reactor 110 is positioned at least partially within the enclosure 120, the reactor system 100 may further comprise an inlet manifold 211 to fluidly connect the inlet 111 of each tubular reactor 110. In the embodiment depicted in FIG. 3, inlet manifold 211 fluidly connects inlet 111a of tubular reactor 110a and inlet 111b of tubular reactor 110b such that hydrocarbon feed stream 102 may be passed to both inlet 111a and inlet 111b. Additionally, the reactor system 100 may comprise an outlet manifold 112 to fluidly connect the outlet 112 of each tubular reactor 110. Still referring to FIG. 3, outlet manifold 212 fluidly connects outlet 112a of tubular reactor 110a and outlet 112b of tubular reactor 110b so that product stream 104 may be passed from the tubular reactors 110a and 110b. It should be noted that the inlet manifold 211 and the outlet manifold 212 may be configured to accommodate any number of tubular reactors 110 positioned within the enclosure 120.

Referring again to FIG. 1, the wall 113 of the tubular reactor 110 may be connected to a first electrical current source 131. Passing a first electrical current through the wall 113 of the tubular reactor 110 may heat the wall of the tubular reactor 110 by electric resistance heating. Without being bound by theory, electric resistance heating may take place by means of the “Joule effect.” According to Joule's first law, the power of heating generated by an electrical conductor is proportional to the product of its resistance and the square of the current. Joule's first law is given in Equation 1, where P is power, I is current, and R is resistance.

$$P = {I}^{2} R . \qquad Equation 1$$

In one or more embodiments, the wall 113 of the tubular reactor 110 may be connected to the first electrical current source 131 proximate to the inlet 111 of the tubular reactor 110 and the outlet 112 of the tubular reactor. For example, and without limitation, the first electrical current source 131 may be connected to the wall 113 of the tubular reactor 110 at a point within 5%, 10%, 15%, or even 20% of the length of the wall 113 from the inlet 111 of the tubular reactor 110. Likewise, the first electrical current source 131 may be connected to the wall 113 of the tubular reactor 110 at a point within 5%, 10%, 15%, or even 20% of the length of the wall 113 from the outlet 112 of the tubular reactor 110.

In one or more embodiments, the wall 113 of the tubular reactor 110 may be further connected to the first electrical current source 131. For example, and without limitation, a third connection to the first electrical current source 131 may be made between the connections proximate the inlet 111 and outlet 112. In one or more embodiments, a third connection between the first electrical current source 131 and the wall 113 of the tubular reactor 110 may be made at a point within 5%, 10%, 15, or even 20% of the length of the wall 113 from a midpoint of the wall 113 from the inlet 111 to the outlet 112 of the tubular reactor 110. Without intending to be bound by theory, when a third connection between the wall 113 of the tubular reactor 110 and the first electrical current source 131 is made, two heating zones may be created in the wall 113 of the tubular reactor 110. It is contemplated that these heating zones may be independently controlled to create two heating zones within the tubular reactor 110. In one or more embodiments, additional connections between the first electrical current source 131 and the wall 113 of the tubular reactor 110 may be made to create additional heating zones within the tubular reactor 110.

In one or more embodiments, the wall 113 of the tubular reactor 110 may be electrically conductive. In one or more embodiments, the wall 113 of the tubular reactor 110 may have an electric resistivity from 1.0 to 4.0μΩ·m at 900° C., from 1.0 to 3.5μΩ·m at 900° C., from 1.0 to 3.0μΩ·m at 900° C., from 1.0 to 2.5μΩ·m at 900° C., from 1.0 to 2.0μΩ·m at 900° C., from 1.0 to 1.5μΩ·m at 900° C., from 1.5 to 4.0μΩ·m at 900° C., from 1.5 to 3.5μΩ·m at 900° C., from 1.5 to 3.0 μΩ·m at 900° C., from 1.5 to 2.5 μΩ·m at 900° C., from 1.5 to 2.0 μΩ·m at 900° C., from 2.0 to 4.0μΩ·m at 900° C., from 2.0 to 3.5μΩ·m at 900° C., from 2.0 to 3.0μΩ·m at 900° C., from 2.0 to 2.5μΩ·m at 900° C., from 2.5 to 4.0μΩ·m at 900° C., from 2.5 to 3.5μΩ·m at 900° C., from 2.5 to 3.0μΩ·m at 900° C., from 3.0 to 4.0μΩ·m at 900° C., from 3.0 to 3.5μΩ·m at 900° C., or from 3.5 to 4.0 μΩ·m at 900° C. In one or more embodiments, the electrical resistivity of the wall 113 of the tubular reactor 110 may vary over the length of the wall 113.

In one or more embodiments, the tubular reactor 110 may have an inner diameter of from 1 to 6 inches (in) from 1 to 5 in, from 1 to 4 in, from 1 to 3 in, from 1 to 2 in, from 2 to 6 in, from 2 to 5 in, from 2 to 4 in, from 2 to 3 in, from 3 to 6 in, from 3 to 5 in, from 3 to 4 in, from 4 to 6 in, from 4 to 5 in, or from 5 to 6 in. In one or more embodiments, the wall 113 of the tubular reactor may have a thickness of from 0.1 to 1.5 in, from 0.1 to 1.25 in, from 0.1 to 1.0 in, from 0.1 to 0.75 in, from 0.1 to 0.5 in, from 0.1 to 0.25 in, from 0.25 to 1.5 in, from 0.25 to 1.25 in, from 0.25 to 1.0 in, from 0.25 to 0.75 in, from 0.25 to 0.5 in, from 0.5 to 1.5 in, from 0.5 to 1.25 in, from 0.5 to 1.0 in, from 0.5 to 0.75 in, from 0.75 to 1.5 in, from 0.75 to 1.25 in, from 0.75 to 1.0 in, from 1.0 to 1.5 in, from 1.0 to 1.25 in, or from 1.25 to 1.5 in. In one or more embodiments, the wall 113 of the tubular reactor 110 may have a length of from 10 to 60 meters (m), from 10 to 50 m, from 10 to 40 m, from 10 to 30 m, from 10 to 20 m, from 20 to 60 m, from 20 to 50 m, from 20 to 40 m, from 20 to 30 m, from 30 to 60 m, from 30 to 50 m, from 30 to 40 m, from 40 to 60 m, from 40 to 50 m, or from 50 to 60 m. It is contemplated that the inner diameter, the wall thickness or both may vary over the length of the wall 113 of the tubular reactor 110.

The first electrical current source 131 may be any suitable source of electrical current. The first electrical current source 131 may be operable to provide alternating current or direct current to the wall 113 of the tubular reactor 110. For example, without any limitation, a suitable electrical current source may be a commercially available power step-down transformer, such as a Thyristor type transformer from Fuji Electric.

In one or more embodiments, passing a first electrical current through the wall 113 of the tubular reactor 110 may heat at least a portion of the wall 113 of the tubular reactor 110. In one or more embodiments, the wall 113 of the tubular reactor 110 may be heated to a temperature of from 600° C. to 1100° C. For example, and without limitation, the wall 113 of the tubular reactor 110 may be heated to a temperature of from 600° C. to 1100° C., from 700° C. to 1100° C., from 800° C. to 1100° C., from 900° C. to 1100° C., from 1000° C. to 1100° C., from 600° C. to 1000° C., from 600° C. to 900° C., from 600° C. to 800° C., from 600° C. to 700° C., or any combination or subset of these ranges.

Referring again to FIG. 1, the enclosure 120 may comprise at least one heating element 130 positioned between the interior surface 124 of the side wall 123 of the enclosure 120 and the exterior surface 114 of the tubular reactor 110. The heating element 130 may be operable to convert electricity to heat. Suitable heating elements may be described in International Publication No. WO 2020/002326 A1, the entirety of which is incorporated by reference herein.

In one or more embodiments, the heating element 130 may convert electricity into heat by electric resistance heating, as described hereinabove. In one or more embodiments, the heating element 130 may comprise NiCr, SiC, MoSi₂, graphite, or FeCrAl as the material through which electrical current is passed to generate heat. In one or more embodiments, the heating element 130 may comprise silicon carbide (SiC). In one or more embodiments, the heating element 130 may take any suitable form. For example, and without limitation, the heating element 130 may comprise a round wire, a flat wire, twisted wires, strips, rods, rod over band, etc. In one or more embodiments, the heating elements 130 may be resistant to exposure to air, to hydrocarbons, and to steam. Without intending to be bound by theory, the heating elements may be resistant to hydrocarbons and steam so they are not damaged in the event that hydrocarbons or steam are released by a failure of one of the tubular reactors that results in the release of reactants, products, or both. However, it should be noted that suitable heating elements are not limited solely to those that are resistant to exposure to hydrocarbons or steam.

In one or more embodiments, the heating elements 130 may have a resistivity from 1.0 to 4.0μΩ·m at 900° C., from 1.0 to 3.5μΩ·m at 900° C., from 1.0 to 3.0μΩ·m at 900° C., from 1.0 to 2.5μΩ·m at 900° C., from 1.0 to 2.0μΩ·m at 900° C., from 1.0 to 1.5μΩ·m at 900° C., from 1.5 to 4.0μΩ·m at 900° C., from 1.5 to 3.5μΩ·m at 900° C., from 1.5 to 3.0μΩ·m at 900° C., from 1.5 to 2.5 μΩ·m at 900° C., from 1.5 to 2.0 μΩ·m at 900° C., from 2.0 to 4.0 μΩ·m at 900° C., from 2.0 to 3.5μΩ·m at 900° C., from 2.0 to 3.0μΩ·m at 900° C., from 2.0 to 2.5μΩ·m at 900° C., from 2.5 to 4.0μΩ·m at 900° C., from 2.5 to 3.5μΩ·m at 900° C., from 2.5 to 3.0μΩ·m at 900° C., from 3.0 to 4.0μΩ·m at 900° C., from 3.0 to 3.5μΩ·m at 900° C., or from 3.5 to 4.0μΩ·m at 900° C.

The enclosure 120 may comprise more than one heating element 130. It should be noted that the number of heating elements 130 positioned within the enclosure 120 may depend on the dimensions of the enclosure 120, the number of tubular reactors 110 within the enclosure 120, the position of the tubular reactors 110 within the enclosure 120, the desired temperature of the tubular reactors 110 and the desired heat flux from the heating elements 130 to the tubular reactors 110. Without intending to be bound by theory, when multiple heating elements 130 are positioned within the enclosure 120, the heating elements 130 may be controlled in groups or even individually. Separate control of groups of heating elements 130 may allow for various heating zones to be independently controlled within the enclosure 120.

In one or more embodiments, the heating element 130 is connected to a second electrical current source 132. The second electrical current source 132 may be any suitable source of electrical current. The second electrical current source 132 may be operable to provide alternating current or direct current to the heating element 130. For example, without any limitation, a suitable electrical current source may be a commercially available power step-down transformer, such as a Thyristor type transformer from Fuji Electric. In one or more embodiments, power supply 132 may include a silicon-controlled rectifier (SCR) that provides discontinuous current to a resistive element or a variable voltage power source that provides continuous voltage changes in discrete steps. The current from the latter can be measured using conventional means. The current output from the SCR and thyristor power supplies, on the other hand, are discontinuous in nature and accurate measurement of the resulting discontinuous current may use techniques that consider the non-sinusoidal nature of the output waveform. In one or more embodiments, multiple heating elements 130 may be connected in series or parallel, or combinations thereof to tailor total heater circuit resistance, heater zone design, and voltage and current for the heating elements (e.g., material electrical resistivity, geometry, cross-sectional area, and element length) so that the desired heating power is achieved. It should be noted that the amount of current passed from the first electrical current source 131 and the amount of current passed from the second electrical current source 132 may be controlled independently so that the proportion of heat supplied to the system by the heating element 130 and through resistive heating of the wall 113 of the tubular reactor 110 may be controlled independently.

In one or more embodiments, passing a second electrical current through the heating element 130 may heat at least a portion of the heating element 130. The heating elements 130 may be able to achieve temperatures of at least 1000° C., at least 1100° C., at least 1200° C., at least 1300° C., at least 1400° C., at least 1500° C., at least 1600° C., at least 1700° C., at least 1800° C., or even at least 1900° C. by electric resistance heating. For example, and without limitation, the heating element 130 may have a temperature of from 1000° C. to 1900° C., from 1100° C. to 1900° C., from 1200° C. to 1900° C., from 1300° C. to 1900° C., from 1400° C. to 1900° C., from 1500° C. to 1900° C., from 1600° C. to 1900° C., from 1700° C. to 1900° C., from 1800° C. to 1900° C., from 1000° C. to 1800° C., from 1000° C. to 1700° C., from 1000° C. to 1600° C., from 1000° C. to 1500° C., from 1000° C. to 1400° C., from 1000° C. to 1300° C., from 1000° C. to 1200° C., from 1000° C. to 1100° C., or any combination or subset of these values.

In one or more embodiments, heat may be transferred from the heating element 130 to the wall 113 of the tubular reactor 110. The heat may be transferred by radiation, convection, or combinations of these. For example, and without limitation, heat may radiate from the surface of the heating element 130 directly to the exterior surface 114 of the wall 113 of the tubular reactor 110. Additionally, heat may radiate from the heating element 130 to the interior surface 124 of the enclosure 120. In turn, heat may radiate from the interior surface 124 of the enclosure 120 to the exterior surface 114 of the wall 113 of the tubular furnace 110. Additionally, gasses contained within the enclosure may rise by the heating element 130 and fall by the tubular reactor 110 heating the wall of the tubular reactor 110 by convection. In one or more embodiments, the exterior surface 114 of the wall 113 of the tubular reactor 110 is spaced apart from the heating element 130. In such embodiments, heat generally may not transfer from the heating element 130 to the wall 113 of the tubular reactor 110 by conduction.

As described herein, the wall 113 of the tubular reactor 110 may be heated by electric resistance heating of the wall 113 of the tubular reactor 110 and by radiative heating from the heating element 130. In one or more embodiments, the heating elements 130 may provide from 10% to 50% of the heat to the wall 113 of the tubular reactor 110. For example, the heating elements 130 may provide from 10% to 50%, from 20% to 50%, from 30% to 50%, from 40% to 50%, from 10% to 40%, from 10% to 30%, from 10% to 20%, or any combination or subset of these values, of the heat to the wall 113 of the tubular reactor 110.

In one or more embodiments, resistance heating of the wall 113 of the tubular reactor 110 may provide from 50% to 90% of the heat to the wall 113 of the tubular reactor 110. For example, resistance heating of the wall 113 of the tubular reactor 110 may provide from 50% to 90%, from 60% to 90%, from 70% to 90%, from 80% to 90%, from 50% to 80%, from 50% to 70%, from 50% to 60%, or any combination or subset of these values, of the heat to the wall 113 of the tubular reactor 110.

Without intending to be bound by theory, using both electric resistance heating of the wall 113 of the tubular reactor 110 and radiant heating of the wall 113 from heating element 130 may provide several advantages compared to systems that use only radiant heating of the wall 113 or only resistive heating of the wall 113. For example, the use of both radiant and resistive heating of the wall 113 may provide an even temperature profile in the wall 113 of the tubular reactor 110 in a radial direction. This may reduce material stress within the wall 113 of the tubular reactor 110 while the reactor 110 is at an operating temperature. Additionally, the even temperature profile may allow for electrical current to more evenly pass through the wall 113 of the tubular reactor 110. This may prevent the formation of hot spots within the wall 113 of the tubular reactor 110, which could result in uneven heating of the hydrocarbons passing through the tubular reactor.

Additionally, without intending to be bound by theory, the use of both radiant and resistive heating of the wall 113 of the tubular reactor 110 may allow the system to have greater operational flexibility, specifically with regard to shifting heating mechanisms during different stages of operation. For example, during startup of the reactor, radiant heating may be used to bring the reactor tubes up to a temperature at which resistive heating is more efficient. This may reduce the amount of energy necessary to start up the reactor system 100. During steady-state operation of the reactor system 100, resistive heating of the wall of the tubular reactor may be the primary heat source and radiant heating may be used to reduce heat loss from the wall 113 of the tubular reactor. Radiant heating may also compensate for heat losses from side wall 123. Furthermore, the use of both radiant heating and resistive heating allows for the reactor to be put into a “hot-standby” mode of operation, where radiant heating is used to maintain the temperature of the reactor near operating temperature while resistive heating of the tube is stopped. This mode of operation may be useful in situations where a reaction is not currently taking place in the reactor, but a full shutdown of the reactor system 100 is not desired. Specifically, the hot-standby mode may prevent losses of energy associated with a full shutdown of the reactor system 100 when a relatively brief pause in operation is desired.

Furthermore, without intending to be bound by theory, the use of both radiant and resistive heating of the wall 113 of the tubular reactor 110 may spread the heating load across multiple heating elements. Specifically, heating elements 130 may provide radiant heating to the wall 113 of the tubular reactor 110 and resistive heating of the wall 113 itself may provide heat to the wall 113 of the tubular reactor. Since neither radiant nor resistive heating provides all the heat to the reactor system 100, the reactor system 100 may be able to operate with a reduced number of heating elements 130 relative to conventional systems. Additionally, a wider range of materials may be used in the heating elements 130 and for the walls 113 of the tubular reactors 110, since neither heating mechanism is responsible for providing all the heat to the reactor system 100. Accordingly, less exotic materials may be suitable for the heating elements 130 and the walls 113 of the tubular reactors 110. Less exotic material may be suitable because the maximum system temperatures may be less than those of conventional combustion-fired furnaces, and having both radiant and resistive heating may provide more surface area to deliver the required heat flux, reducing thermal stress on the heating elements 130 and increasing the material lifetimes. For example, without limitation, less exotic materials for the heating elements 130 may include Nickel Chromium (NiCr 80/20), Nickel Chromium (NiCr 70/30), both capable of operating at temperature exceeding 1100° C., along with Ferritic iron-chromium-aluminum alloy (FeCrAl), capable of 1400° C. operating temperature, and having good electrical resistance and with very good oxidation resistance.

Also, without intending to be bound by theory, the use of both radiant and resistive heating of the wall 113 of the tubular reactor 110 may allow for more freedom in the arrangement of the tubular reactors 110 and the heating elements 130 within the enclosure 120. For example, and without limitation, the density of the tubular reactors 110 within the enclosure 120 may be increased relative to reactor systems that rely solely on radiant heating. This may be possible because the heating elements 130 only contribute part of the heat for the reactor system 100, and resistive heating of the walls 113 of the tubular reactors 110 themselves also contributes heat to the reactor system 100. When each tubular reactor 110 is able to provide a portion of the necessary heat by resistive heating, the system may be able to accommodate more tubular reactors 110. Accordingly, increasing the density of the tubular reactors 110 in the enclosure 120 may be possible when both radiant and resistive heating are used.

Furthermore, without intending to be bound by theory, the use of both radiant and resistive heating of the wall 113 of the tubular reactor 110 may allow for independent control of the heating mechanisms. This may allow for the operational flexibility described previously. Additionally, independent control of the heating mechanisms may allow for multiple heating zones to be formed within the enclosure. Without intending to be bound by theory, the use of multiple heating zones may allow for tighter control of the temperature distribution in the enclosure. Additionally, the use of multiple heating zones may increase the overall reliability and runtime of the system when the multiple heating zones are designed to compensate for the loss of a heating zone in the event that one zone fails.

In one or more embodiments, a method for processing chemicals comprises passing a hydrocarbon feed stream 102 to the tubular reactor 110, reacting at least a portion of the hydrocarbon feed stream 102 within the tubular reactor 110 to form a product stream 104 and passing the product stream 104 through the outlet 112 of the tubular reactor 110. It should be noted that reacting the hydrocarbon feed stream 102 to form a product stream 104 may include performing any endothermic reaction. In some embodiments, the endothermic reaction may be a steam cracking reaction, a steam reforming reaction, or a hydroprocessing reaction. However, it should be noted that the methods for processing chemicals described herein are not necessarily limited to such reactions.

In one or more embodiments, the reaction may be a steam cracking reaction. However, the described embodiments may have applicability to a wide range of chemical processes. As described herein, a “steam cracking reaction” refers to the thermal cracking of hydrocarbons in the presence of steam to produce products such as hydrogen, olefins, and aromatic hydrocarbons. Without intending to be bound by theory, the pyrolysis reaction of hydrocarbons follows a free radical mechanism, requiring high temperatures. Steam may act as a diluent to reduce the partial pressure of hydrocarbons, which may improve selectivity by promoting higher yields of light olefins.

In one or more embodiments, the hydrocarbon feed stream 102 may comprise at least one of methane, ethane, propane, and butane. In some embodiments, the hydrocarbon feed stream 102 may comprise naphtha or vacuum gas oil. In some embodiments, the hydrocarbon feed stream 102 may comprise C₁ to C₅ hydrocarbons, C₁ to C₂₀ hydrocarbons, or even C₁ to C₅₀ hydrocarbons. In some embodiments, the hydrocarbon feed stream 102 may further comprise water or steam (H₂O), CO₂, CO, N₂, CO, CO₂, H₂, or combinations thereof.

In one or more embodiments, the product stream 104 may comprise at least one of hydrogen, olefins, and aromatic hydrocarbons. The product stream 104 may comprise olefins, such as ethylene, propylene, 1-butene, 2-butene, isobutylene, 1-pentene, 2-pentene, 2-methyl-1-butene, 3-methyl-1-butene, 2-methyl-2-butene, or combinations thereof. In one or more embodiments, the product stream may comprise C₂ to C₁₀ olefins, from C₂ to C₂₀ olefins, or even from C₂ to C₅₀ olefins. In one or more embodiments, the product stream 104 may comprise aromatic hydrocarbons such as benzene and its derivatives. The product stream 104 may comprise benzene, toluene, ethylbenzene, o-xylene, p-xylene, m-xylene, mesitylene, durene, 2-phenylhexane, biphenyl, or combinations thereof.

In one or more embodiments, the product stream 104 may comprise greater than 20 wt. %, greater than 25 wt. %, greater than 30 wt. %, greater than 35 wt. %, or greater than 40 wt. % olefins, aromatic hydrocarbons, or combinations thereof. For example, and without limitation the product stream 104 may comprise from 20 wt. % to 100 wt. %, from 30 wt. % to 100 wt. %, from 40 wt. % to 100 wt. %, from 50 wt. % to 100 wt. %, from 60 wt. % to 100 wt. %, from 70 wt. % to 100 wt. %, from 80 wt. % to 100 wt. %, from 90 wt. % to 100 wt. %, from 20 wt. % to 90 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, or any combination or subset of these ranges of olefins, aromatic hydrocarbons, or combinations thereof.

In one or more embodiments, methods for processing chemicals described herein may further comprise preheating the hydrocarbon feed stream 102. Preheating the hydrocarbon feed stream 102 may occur before passing the hydrocarbon feed stream 102 to the inlet 111 of the tubular reactor 110. In one or more embodiments, preheating the hydrocarbon feed stream 102 may comprise passing the hydrocarbon feed stream 102 through a heat exchanger 141. In one or more embodiments, the hydrocarbon feed stream 102 may be passed through multiple heat exchangers in parallel, in series, or a combination of both. The heat exchanger 141 may be any suitable heat exchanger including, but not limited to, a shell and tube heat exchanger. Preheating the hydrocarbon feed stream 102 may increase the temperature of the hydrocarbon feed stream 102 to a temperature of 300° C., 400° C., 500° C., or even 600° C. In one or more embodiments, the temperature of the hydrocarbon feed stream 102 exiting the heat exchanger 141 may be below the temperature of the wall 113 of the tubular reactor 110.

In one or more embodiments, the methods for processing chemicals described herein may further comprise cooling the product stream 104 in a heat exchanger 142. The heat exchanger 142 may cool the product stream 104 to below the reaction temperature. Cooling the product stream 104 below the reaction temperature may prevent further reactions, or conversion, of the product stream 104. In one or more embodiments, the heat exchanger 142 may cool the product stream 104 to a temperature below 1200° C., below 1000° C., below 800° C., below 600° C., or even below 500° C. In one or more embodiments, the heat exchanger 142 may comprise a quench exchanger or any other suitable heat exchanger. In some embodiments, heat removed from the product stream 104 may be used to heat the hydrocarbon feed stream 102. In one or more embodiments, cooling the product stream 104 may take place in multiple heat exchangers in parallel, in series, or a combination of both.

It should be noted that method steps set forth herein should not be construed as requiring that the steps be performed in a specific order, unless otherwise specified. For example, and without limitation, it is contemplated that in a method for processing chemicals described herein, the method steps of passing a first electrical current through at least a portion of the wall of the tubular reactor to heat at least a portion of the wall of the tubular reactor and passing a second electrical current through the heating element to heat at least a portion of the heating element do not necessarily have to be performed in any particular order, and a claim reciting these method steps should not be construed as requiring them in any particular order. It is contemplated that in one or more embodiments described herein the method steps of passing a first electrical current through at least a portion of the wall of the tubular reactor and passing a second electrical current through the heating element may occur at any point in a method for processing chemicals described herein. Specifically, such method steps may occur before, during, and after passing a hydrocarbon feed stream through the inlet of the tubular reactor, before, during, and after the hydrocarbon feed stream is reacted to form a product stream, and before, during, and after the product stream is being passed from the tubular reactor.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

Additionally, the term “consisting essentially of” is used in this disclosure to refer to quantitative values that do not materially affect the basic and novel characteristic(s) of the disclosure. For example, a chemical composition “consisting essentially” of a particular chemical constituent or group of chemical constituents should be understood to mean that the composition includes at least about 99.5% of a that particular chemical constituent or group of chemical constituents.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

1. A method for processing chemicals, the method comprising:
passing a hydrocarbon feed stream through an inlet of a tubular reactor, wherein:
the tubular reactor comprises the inlet, an outlet, and a wall extending at least from the inlet to the outlet;
the tubular reactor is positioned at least partially within an enclosure;
the enclosure comprises a first end, a second end, and at least one side wall extending from the first end to the second end; and
the enclosure comprises at least one heating element positioned between an interior surface of the side wall of the enclosure and an exterior surface of the wall of the tubular reactor;
passing a first electrical current through at least a portion of the wall of the tubular reactor to heat at least a portion of the wall of the tubular reactor;
passing a second electrical current through the heating element to heat at least a portion of the heating element such that heat transfers from the heating element to the wall of the tubular reactor;
reacting at least a portion of the hydrocarbon feed stream within the tubular reactor to form a product stream;
passing the product stream through the outlet of the tubular reactor.

2. The method of claim 1, wherein the heating element is spaced apart from the exterior surface of the wall of the tubular reactor.

3. The method of claim 1, wherein the side wall of the enclosure is spaced apart from the exterior surface of the wall of the tubular reactor.

4. The method of claim 1, wherein a cross-sectional area of the tubular reactor, perpendicular to a bulk flow of the hydrocarbon feed stream through the tubular reactor, is substantially constant from the inlet of the tubular reactor to the outlet of the tubular reactor.

5. The method of claim 1, wherein from 2 to 50 of the tubular reactors of claim 1 are positioned at least partially within the enclosure.

6. The method of claim 5, wherein the tubular reactors are connected to an inlet manifold to fluidly connect the inlet of each tubular reactor and the tubular reactors are connected to an outlet manifold to fluidly connect the outlet of each tubular reactor.

7. The method of claim 1, wherein the heating element comprises NiCr, SiC, MoSi₂, graphite or FeCrAl.

8. The method of claim 1, wherein the first electrical current, the second electrical current, or both comprise alternating current.

9. The method of claim 1, wherein the first electrical current, the second electrical current, or both comprise direct current.

10. The method of claim 1, wherein the hydrocarbon feed stream comprises one or more of ethane, propane, butane, naphtha, and vacuum gas oil.

11. The method of claim 1, wherein reacting the hydrocarbon feed stream comprises steam cracking at least a portion of the hydrocarbon feed stream, and the product stream comprises one or more olefins.

12. A reactor system comprising:
a tubular reactor comprising an inlet, an outlet, and a wall extending at least from the inlet to the outlet, wherein the wall of the tubular reactor is connected to a first electrical current source such that at least a portion of the tubular reactor is operable to be heated when the first electrical current is passed through the tubular reactor; and
an enclosure comprising:
a first end, a second end, and at least one side wall extending from the first end to the second end; and
at least one heating element positioned between an interior surface of the side wall of the enclosure and an exterior surface of the wall of the tubular reactor, wherein the heating element is connected to a second electrical current source; and
wherein the tubular reactor is positioned at least partially within the enclosure, such that the heating element is operable to heat at least a portion of the tubular reactor when the second electrical current passes through the heating element.

13. The reactor system of claim 12, wherein the heating element is spaced apart from the exterior surface of the wall of the tubular reactor, and the side wall of the enclosure is spaced apart from the exterior surface of the wall of the tubular reactor.

14. The reactor system of claim 12, wherein from 2 to 50 of the tubular reactors of claim 12 are positioned at least partially within the enclosure.

15. The reactor system of claim 12, wherein the heating element comprises NiCr, SiC, MoSi₂, graphite or FeCrAl.
